(19) United States
(12) Patent Application Publication
(10) Pub. No.: US 2016/0262153 A1
(43) Pub. Date: Sep. 8, 2016

(54) METHODS AND SYSTEMS FOR FORMING NETWORK CONNECTIONS

(71) Applicant: Ray W. Sanders, Los Angeles, CA (US)

(72) Inventor: Ray W. Sanders, Los Angeles, CA (US)

(21) Appl. No.: 15/059,917

(22) Filed: Mar. 3, 2016

Related U.S. Application Data
(60) Provisional application No. 62/127,779, filed on Mar. 3, 2015.
(60) Provisional application No. 62/144,833, filed on Apr. 8, 2015.

(51) Int. Cl. H04W 72/04; H04L 12/707; H04L 12/931

(52) U.S. Cl. CPC H04W 72/0446; H04L 49/70; H04L 45/22

(57) ABSTRACT

Systems and methods for forming network connections are described. Embodiments of the systems and methods can include identifying a plurality of network nodes in a network system; partitioning the plurality of network nodes into a disjoint network element; identifying, based on the disjoint network element, a first virtual connection between an entry node and an exit node; assigning a first bandwidth to the first virtual connection; and forming a connection domain among the partitioned plurality of network nodes, the connection domain including the first virtual connection.

### CROSS-REFERENCE TO RELATED APPLICATIONS

Any and all applications for which a foreign or domestic priority claim is identified in the Application Data Sheet as filed with the present application are hereby incorporated by reference under 37 CFR 1.57. This application is related to U.S. application Ser. No. 13/791,709, filed Mar. 8, 2013, titled “APPARATUS AND METHODS OF ROUTING WITH CONTROL VECTORS IN A SYNCHRONIZED ADAPTIVE INFRASTRUCTURE (SAIN) NETWORK,” now issued as U.S. Pat. No. 9,137,201, the disclosure of which is hereby incorporated by reference in its entirety (hereinafter referred to as the '709 App).

### BRIEF DESCRIPTION OF DRAWINGS

FIG. 1 shows a metropolitan area network example with 20 T-Nodes & 80 simplex trunks according to an embodiment. FIG. 1 corresponds to FIG. 5 in the '709 App.

FIGS. 2, 3, and 4 show various configurations of E-Nodes and their T-Node parents according to certain embodiments. FIG. 2-4 correspond to FIGS. 4.1-4.3 respectively in the '709 App, and further described therein.

FIG. 5 shows an illustration of network objects used to pass user data from a source E-Node to a source parent (routing) T-Node through forwarding T-Nodes (as needed) to a destination parent T-Node to a destination E-Node according to an embodiment. FIG. 5 corresponds to FIG. 6 in the '709 App, and further described therein.

FIG. 6 shows source E-Nodes connecting to parent T-Node T3 according to an embodiment. FIG. 6 corresponds to FIG. 6.1 in the '709 App, and further described therein.

FIG. 7 shows forwarding switches in a SAIN architecture according to an embodiment. FIG. 7 corresponds to FIG. 6.2 in the '709 App, and further described therein.

FIG. 8 shows a cross-connect switch according to an embodiment. FIG. 8 corresponds to FIG. 6.3 in the '709 App, and further described therein.

FIG. 9 illustrates a T-Node T7 level 4 forwarding switches connectivity diagram according to an embodiment. FIG. 9 corresponds to FIG. 6.4 in the '709 App, and further described therein.

FIG. 10 shows forwarding switches in a SAIN architecture according to an embodiment. FIG. 10 corresponds to FIG. 6.5 in the '709 App, and further described therein.

FIG. 11 shows destination E-Nodes connecting from parent T-Node T11 according to an embodiment. FIG. 11 corresponds to FIG. 6.6 in the '709 App, and further described therein.

FIG. 12 shows an example aggregation switch stack selector.

FIG. 13 shows an example disaggregation switch stack selector

FIG. 14 shows an example of Level 2 addresses utilized for Path Level 1 traffic.

### DETAILED DESCRIPTION

SAIN networks are underlays for current and future networks. It has benefits in at least eight aspects of networking:
1. Latency
2. Scalability
3. Simplicity
4. OPEX/CAPEX
5. Synchronization
6. Security & Privacy
7. Availability & Survivability
8. Bandwidth & Energy Efficiency

Various embodiments of a Synchronized Adaptive Infrastructure (SAIN) networks are disclosed herein. Such a network includes one or more trunk node that can be referred to as T-Nodes; and egress nodes that can be referred to as E-Nodes. SAIN switches (hereinafter referred to as “Sswitches”) operate in source and destination pairs. A source Sswitch (an sSswitch) can connect to a destination Sswitch (a dSswitch) in a single hop. Accordingly, a single hop in a multi-tiered SAIN network can be obtained. For example, an Sswitch can:
1. set up a plurality of connections between two locations as a source Sswitch (referred to as an sSswitch) and as a destination Sswitch (referred to as a dSswitch) pair,
2. act as an sSswitch aggregator and dSswitch disaggregator of a plurality of connections,
3. act as forwarding sSswitch-dSswitch pairs of a plurality of connections over links in trunks between T Node pairs,
4. operate in frames of small amounts of data called cellets each of which represents a quantum of data bandwidth,
5. operate in the algorithm's transform of a Connection Domain that defines the bandwidth of each connection by the number of its cellets in a frame and a Space/Time Domain that spreads cellets of a connection nearly uniformly throughout the frame,
6. define the total amount of bandwidth allocated to a plurality of connections by total number of cellets in a frame,
7. change the amount of bandwidth allocated to each connection dynamically frame by frame,
8. divide frames of connections into two parts—the transform domains and separately. A Control Vector to manage the bandwidths of the connections and their other parameters out of band.

An Sswitch can accept data from sources at one location and deliver them directly through a dSswitch to sinks at another location. Synchronization and levels of aggregation are major aspects in packet switched SAIN networks. The Sswitches are used to connect source Network Interface Controllers (sNICs) or their equivalent to dNICs.

There are two use case types of sSswitch-dSswitch pairs. A Type I sSswitch-dSswitch pair aggregates a plurality of data connections at one sSswitch location; and delivers the aggregation to a dSswitch that disaggregates the plurality of connections into sinks at another location. A Type I aggregation can travel through one or more serial Type II forwarding sSswitch-dSswitch pairs. In other words, the two types of use of Sswitches can provide routing through multiple connections of sT Node to dT Node links. In this way, a Type I sSswitch connects to a dSswitch as a connection within an aggregation traveling through one or more Type II sSswitch-dSswitch pairs as a single hop.

In one embodiment, a connection can represent a stream bits between two end-points. Packet protocols, if any, may appear at ingress and egress nodes. The Type I source-destination pair appears to be a one-hop aggregation connection in a plurality of connections

A SAIN network can accept user data at a source location and deliver the data transparently to a destination location. In various embodiments, external user data to a SAIN network can be connected in any type of communication protocol. One of the reason for the purpose of a SAIN network is that all forwarding of data is agnostic to user protocols. The following are a few examples:
1. packet traffic such as link-level Ethernet format that encapsulates Internet Protocol (IP) or other format data,
2. aggregations of packet traffic such as aggregations of optical lanes at very high data rates,
3. wireless traffic such as Wi-Fi, 3G, and LTE,
4. circuit-based traffic such as voice, mp3, and MPEG.

Generally described, network data can appear in formats configured for switching or transmission in Network Interface Controllers (NICs) (e.g., as described in other related patents and patent applications such as U.S. Provisional App. No. 61/298,487, filed Jan. 26, 2010, titled “APPARATUS AND METHOD FOR SYNCHRONIZED NETWORKS; and U.S. application Ser. No. 13/013,717, filed Jan. 25, 2011, titled “APPARATUS AND METHOD FOR SYNCHRONIZED NETWORKS,” now issued as U.S. Pat. No. 8,635,347). NICs can involve either hardware or software emulations in data servers or other processers. Like other forwarding objects in a SAIN network, a source NIC (sNIC) pairs with a destination NIC (dNIC). A connection between the two is disjoint from all other connections.

Other methods of building communication systems or other devices exist. Any system or device containing the SAIN Sswitch algorithm or similar scheme is by definition a SAIN system or device.

A SAIN network can have one or a plurality of aggregation levels. Each level can use the same sSswitch (i.e., sSswitch/dSswitch pair) basic structure for each level. Aggregation and/or forwarding may be implemented in a hardware device (e.g., a network switch) or in software instructions stored in memory configured to be executed by a processor. As described herein, a SAIN network can be a plurality of sub-network partitions of the large network. A SAIN network partition can be a disjoint plurality of SAIN sSswitch/dSswitch pairs so that it is disjoint from all other partitions and data connections. For example, a control vector can specify a partition of network nodes that form a disjoint network element. This can be referred to as a connection. That disjoint network element specifies a source (e.g., an entry node) and a destination (e.g., an exit node). The disjoint network element is not impacted by another disjoint network element (e.g., a different connection). Only a control vector can change the sources and addresses of disjoint network elements, thereby altering a connection. By specifying disjoint network elements in a SAIN network, network data communications can be transmitted in a deterministic manner. In various embodiments, a single partition or a plurality of partitions can be a private network. A private network that is a plurality of private partitions can be divided into private sub-networks. For example, such private sub-networks may correspond to various divisions of a company.

Some exemplary levels of aggregation in a SAIN network include:
1. Path Level 1 Aggregation/Disaggregation: This level sSswitch can aggregate sNIC or sNIC-like input data such as that shown above and changes it into the SAIN forwarding protocol. The aggregation can travel through one or a number of methods to connect to the paired dSswitch that can disaggregate the forwarding protocol into its initial form. Path Level 1 can aggregate any number of sNIC-like inputs by either using a Virtual Entry/Exit (a VE-Node) or aggregating a small number of Path Level 1 inputs as a subpart of an E-Node.
2. A Level 2 Aggregation/Disaggregation (sSswitch-dSswitch pair) is associated with a SAIN network object and can be called an Entry/Exit Node (an E-Node). The purpose of an E-Node is to aggregate Path Level 1 packets and data flow aggregations into a next higher aggregation/disaggregation level. Each E-Node can contain a sE-Node with a plurality of sSswitches each of which connects to a dSswitch in a dE-Node that is either in the same or in a different SAIN network partition. In some high traffic cases, any E-Node can require a connection with every other E-Node in a plurality of E-Nodes in the same or in another partition.
3. A Level 3 Aggregation/Disaggregation is associated with forwarding a plurality of all sE-Node Level 2 aggregations nominally between T-Nodes. This description of forwarding traffic in a SAIN network starts below, starting with a simple case to a large network case including among others routing alternatives.

In various embodiments, T-nodes can include a plurality of connections to a plurality of other T-nodes. E-nodes can then be aggregated at an origin T-node, and then transmitted based on their destination using at least one of the plurality of connections to other T-nodes. In one embodiment, if a T-node has five E-nodes, two of the five E-nodes can be communicated via one connection to another T-node; and the remaining three of five E-nodes can be communicated via a different connection to a different T-node. Accordingly, various methods of aggregation can be accomplished at a particular T-node for destinations across the network to different T-nodes, using various routes.

### Where NICs can Exist in the SAIN Network

A sNIC can be virtually available to several dNICs that are in partitions entered from a sNIC's source partition. For example, in one embodiment, a sNIC can be available to all dNICs. Each sNIC may be required to meet some methods or restrictions that enhance security and privacy for authorized uses. For example, such methods or restrictions can include:
1. meet private partition restrictions, and/or
2. meet physical location restrictions, and/or
3. meet user authorization controls, and/or
4. use restricted encryption methods, and/or
5. meet Control Vector restrictions, and/or
6. assure that dNIC meet sNIC verification updates, and/or
7. meet biological aspects (e.g., bio-data, fingerprints).

A sNIC can be capable of connecting to more than one dNIC simultaneously or at least in a round robin fashion. sNICs and their ports can be available directly or indirectly to E-Nodes. This can enable a NIC access to a Path Level 1 aggregation to parent E-Nodes. As the number of sNICs can be required to multi-connect to dNICs at many places in SAIN network possibilities, in some embodiments, it may be desirable to have all sNICs and their ports to be available directly or indirectly to E-Nodes. This would also enable sNIC access to sVE-Nodes that can connect to parent E-Nodes.

A SAIN Network can Use a Single VE-Node with a Single E-Node

In some embodiments, to complete a connection between a sNIC-dNIC with a single parent Path Level 1 can occur with a Path Level 1 sSswitch connects physically to a dSswitch in Path Level 1. For example, a clocked connection can come from a parent E-Node's sE-Node-dE-Node pair. In this manner, the sSswitch-dSswitch pair could support a plurality of sNIC-dNIC connections within the Path Level 1.

One or more clock sources can exist in any SAIN network such as 1) a master clock sets the frequency, or 2) a master clock sets phase and frequency, or 3) a plurality of nodal clocks that operate at nearly the same frequency with variable phase. Disclosure of such methods exists in a prior patent application.

A SAIN Network with a Plurality of E-Nodes and a Single T-Node

A SAIN network can include a single parent T-Node with a plurality of child E-Nodes. The T-Node can include a source T-Node (sT-Node) and a destination T-Node (dT-Node). Likewise, each E-Node can contain a source E-Node (sE-Node) and a destination E-Node (dE-Node). The purpose of an sE-Node is to aggregate all Path Level 2 connections that originate in the source E-Node's source NICs (sNICs) that connect to one or more destination NICs (dNICs) in each of the network's dE-Nodes.

If there are N E-Nodes connected to the single T-Node, there will be an aggregation of either N or N−1 Path Level 1 aggregations. There will be N if all E-Nodes in the network if the sNICs of the sE-Node that connect with the dNICs of the sE-Node are included. There are N−1 if the sE-Node's dNICs are excluded since they can be included in the single E-Node network disclosed above.] As described herein, there is an assumption that N Path Level 2 aggregations create a Level 2 aggregation. In other words, since there are N E-Nodes each with N Path Level 2 aggregations, there are a total of N2 Path Level 2 aggregations in the network.

What the sT-Node receives from each of the connected sE-Node Level 2 aggregation is one Path Level 2 aggregation for each of the dE-Node Level 2 disaggregations. Accordingly, a Crossconnect function can take place between the sT-Node and the dT-Node. This function can interconnect dSswitch-sSswitch combinations.

Numbering each sE-Node as sE-Node 0 to E-Node N. The number of each Level 2 aggregation element from sE-Node 0 sE-Node 00, sE-Node 01, . . . sE-Node 0N. Each first number shows the number of the sE-Node. The second number is number of the dE-Node to which the Level 2 aggregation element belongs.

### How an E-Node Pair can Contain Both a Level 1 and Level 2 Aggregation.

An E-Node can be the parent of a large number of NICs, both sNICs and dNICs. However, that does not mean that there will be a large number of connections between a sE-Node in one SAIN network partition and dE-Node in every other. This might occur in a large organization such as a company or a government entity. In such instances, it is not necessary to set up a Path Level 1 pair—one in the sE-Node and one in the dE-Node. The sE-Node could be in one partition and the dE-Node in another partition. In a SAIN network, every sNIC could have a virtual connection with every dNIC. However, such a connection can only exist where the sNIC and dNIC exist in the same partition or sub-partition or meet special authorization to consummate a connection. Some of the authorization embodiments are included herein.

A SAIN Network with a Plurality of E-Nodes and a Plurality of T-Nodes

In some embodiments, there is one major difference and one small difference between “A SAIN network with a plurality of E-Nodes and a single T-Node” and “A SAIN network with a plurality of E-Nodes and a plurality of T-Nodes.” The major difference can be that the single T-Node network is a single partition. The plurality of T-Nodes can be a partition with a plurality of sub-partitions. If there are 20 T-Nodes in a network, each one considered by itself can be one of 20 independent networks. Considering all 20 as a network together is a major difference. Each of the 20 partitions can interconnect only where mutual NIC authorization exists including methods such as those outlined in paragraph [0006] above.

### Routing in a SAIN Network

Comparing Routing in a SAIN Network with the Current Internet

Current packet networks rely on complex hop-by-hop methods such as Ethernet protocols (often labeled as OSI ‘Layer 2’) and Internet protocol networks (often labeled as OSI ‘Layer 3’). In contrast, SAIN networks can connect and transfer any protocol receivable by a sNIC and deliverable by a dNIC. What is receivable at a sNIC can be any OSI protocol layer. Packet traffic at any OSI layer entering a sNIC connected to an sSswitch can be the same OSI layer being delivered at a paired dNIC.

### The Two Methods of Synchronization Available in a SAIN Network

Synchronization can be an important parameter in some embodiments of a SAIN network. In some embodiments, it can be important when it comes to forwarding routes in a network. As two examples, some methods can achieve synchronization: One is to time-align all routes with one another; and the other is to use the SAIN method of aligning each aggregation stream with a framing method.

### Advantages of Partitions

A SAIN network can be divisible into partitions. In some embodiments, this has three advantages: 1) it can assure security and privacy of private networks; 2) it can simplify routing by using a method of aligning aggregations; and 3) such a method can further assure security and privacy.

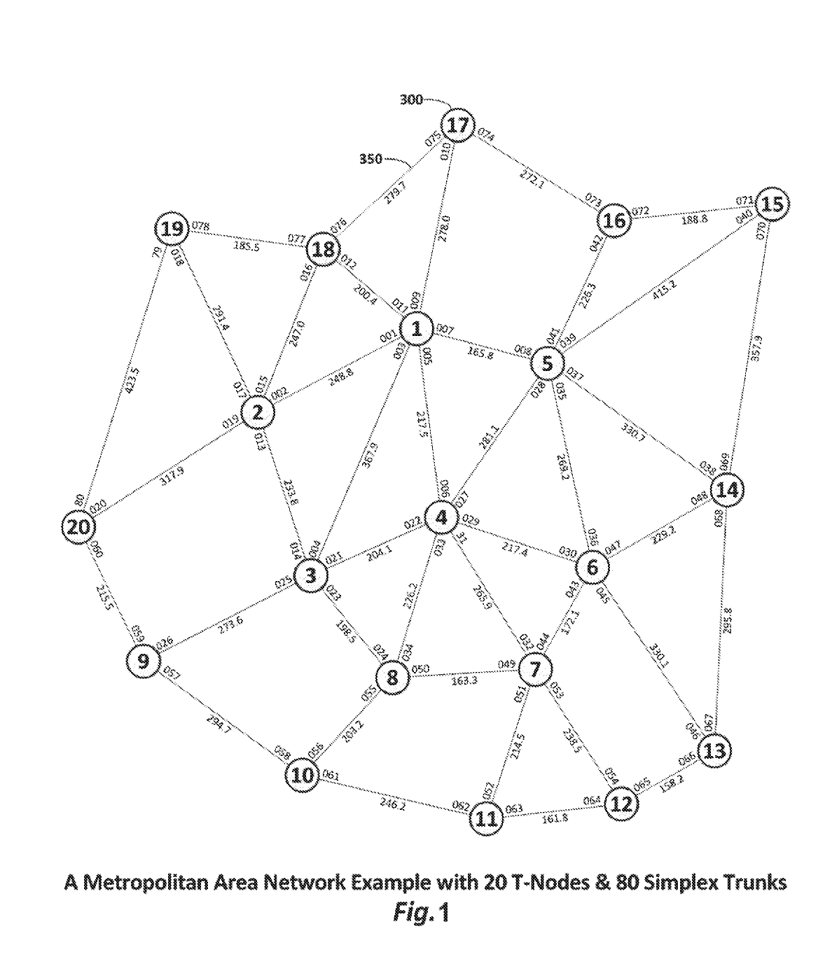

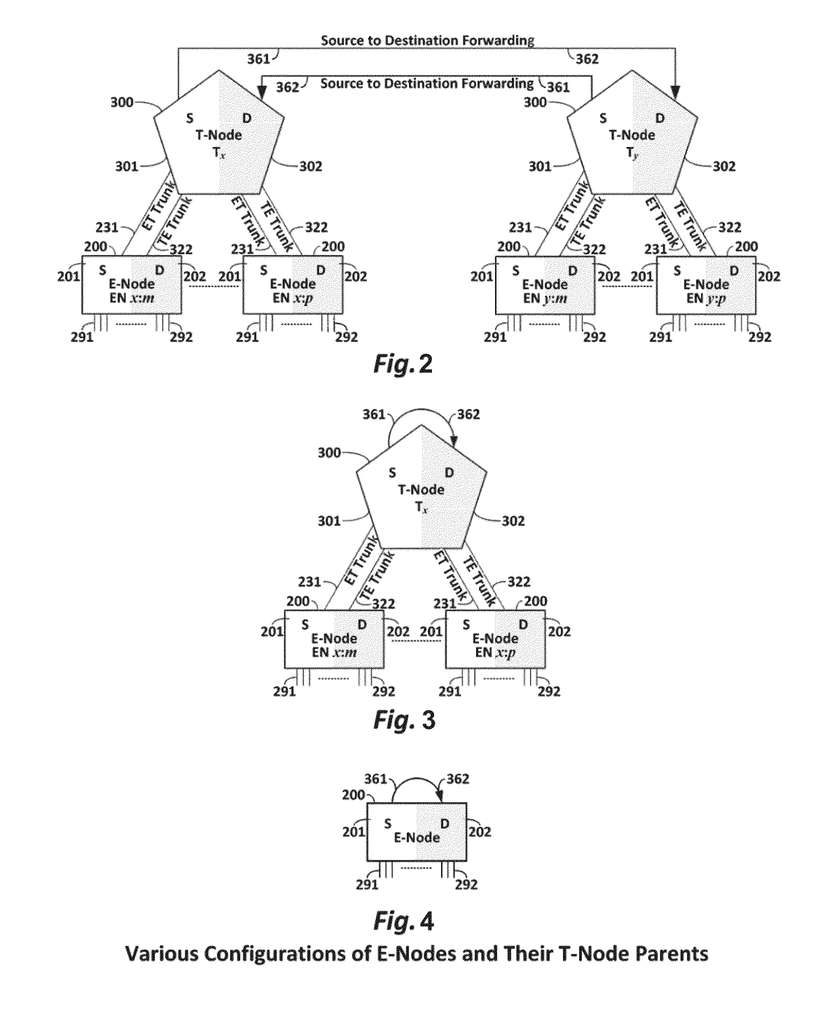

FIG. 1 depicts a 20-T-Node model used for illustrating the methods of SAIN networking. One aspect of SAIN can be to divide a network into partitions each of which can contain a T-Node as shown in the figure. FIG. 2 shows an example of connected T-Nodes including a cluster of E-Nodes, each of which is connected to the T-Node as its parent.

A partition includes a cluster of E-Nodes connected to a parent sT-Node. Each E-Node can easily have their switch synchronizing all of the sE-Node-to-dE-Node connections. But, in some embodiments, because many of the synchronized connections are important, the distance of one sE-Node from a parent sT-Node in a partition is not the same as another. If the time-aligned method of synchronization is used, it can require that the systems must delay all aggregation streams to be time aligned with the most delayed stream. Accordingly, this method of framing removes the need for such delays.

### Defining Possible Structures in a SAIN Network

In a SAIN network, each E-Node can have a virtual connection not only with every E-Node in the network, but also with every E-Node in a more global sense. FIG. 1 depicts one embodiment of this connectivity. For example, FIG. 3 shows a partition made up of a single T-Node. Further, FIG. 4 shows how a T-Node in one partition can connect to a partition with a different T-Node. Assumed is that each E-Node connects through ports to a subset of all NICs in a network. In other words, any NIC in connected to an E-Node can have a virtual connection to every NIC in a SAIN network.

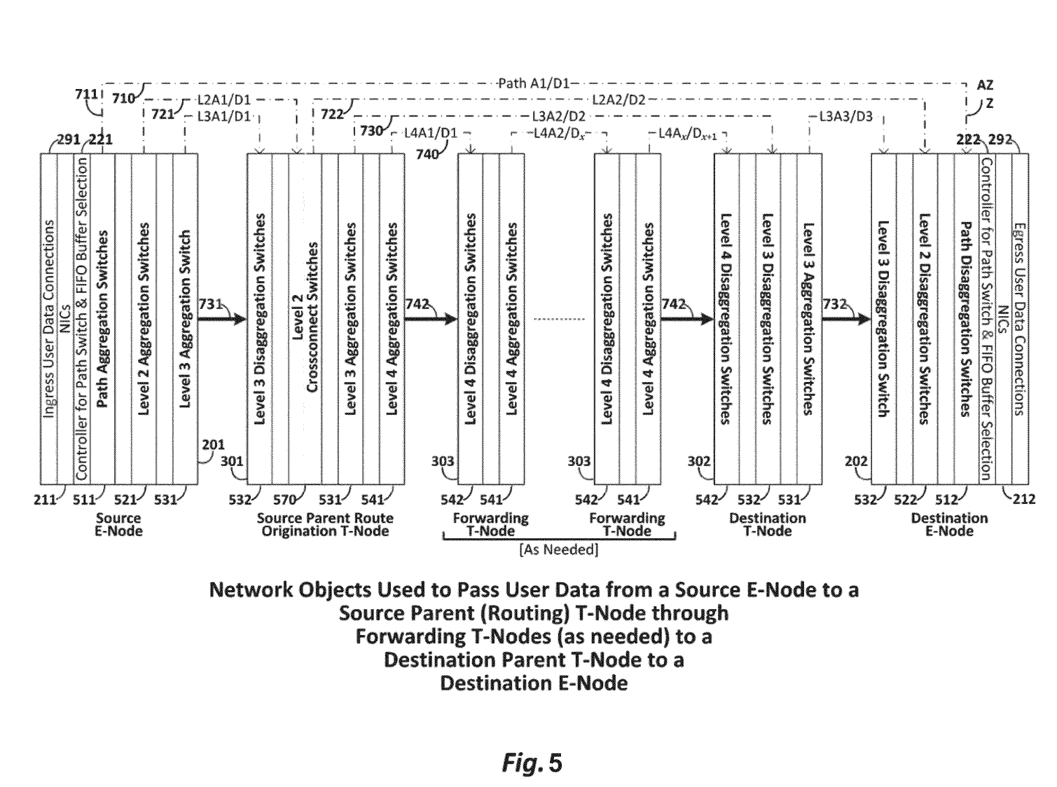

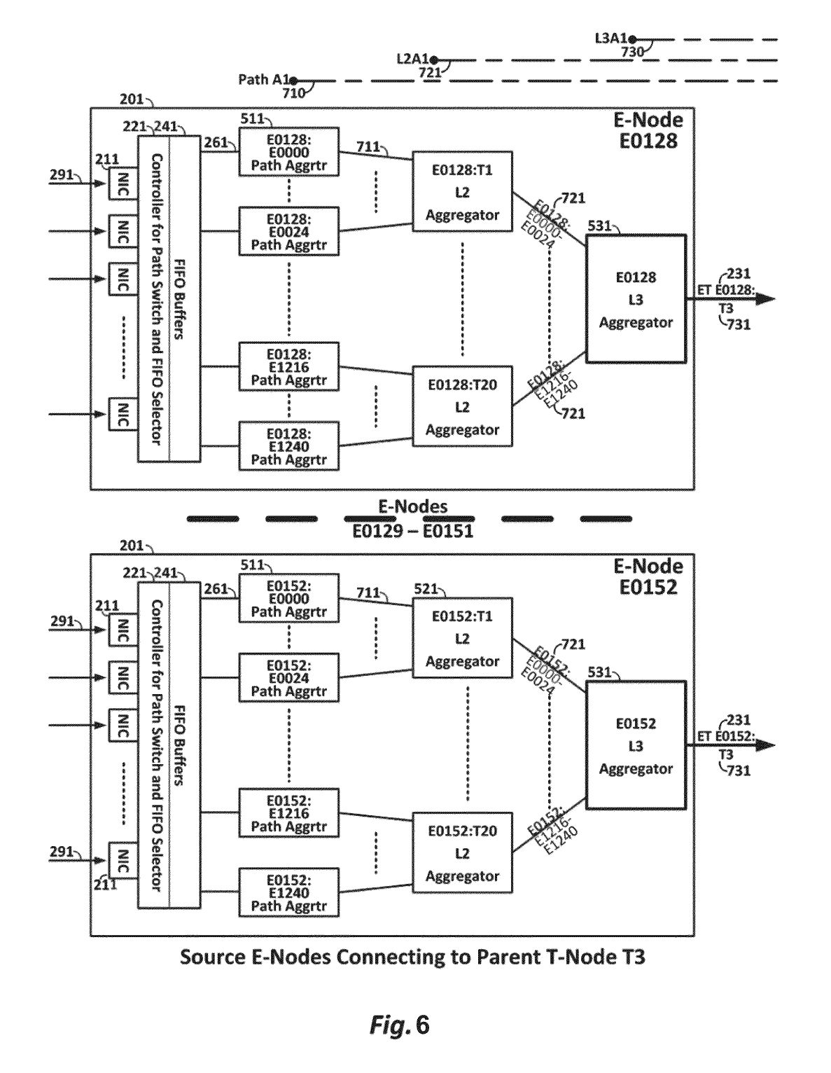

A SAIN network aggregates data inputs from users into sNICs that connect to a paired dNIC in a single hop. The connection can exist within a plurality of other connections within aggregations of connections. There are virtual connections in a SAIN network between any two E-Nodes within a SAIN network or even in E-Nodes in other SAIN networks. The aggregations that exist within a pair of E-Nodes are Layer 2 in the model network. Each Layer 2 aggregation contains all connections between those sNICs that are sending to a dNIC that connects to a paired dE-Node. Routing in a SAIN network leads each such Layer 2 aggregation of Path Level 2 connections. For example, FIG. 5 shows an illustration of network objects used to pass user data from a source E-Node to a source parent (routing) T-Node through forwarding T-Nodes (as needed) to a destination parent T-Node to a destination E-Node according to an embodiment. As another example, FIG. 6 shows source E-Nodes connecting to parent T-Node T3 according to an embodiment.

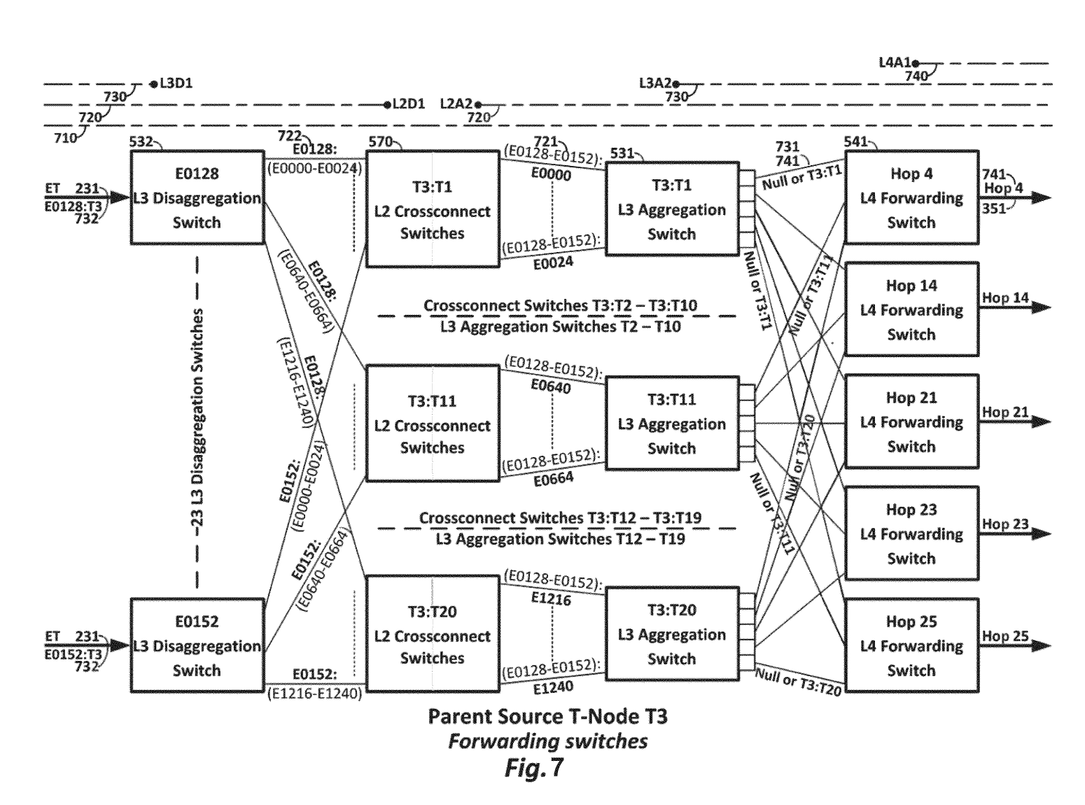

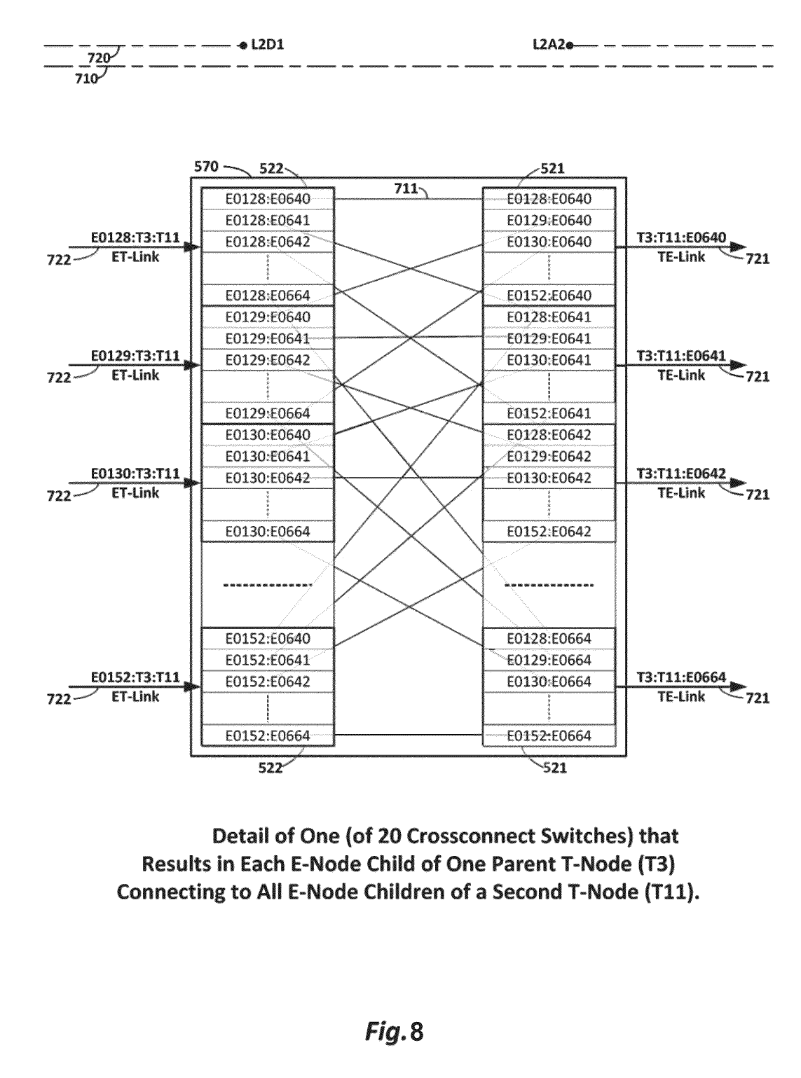

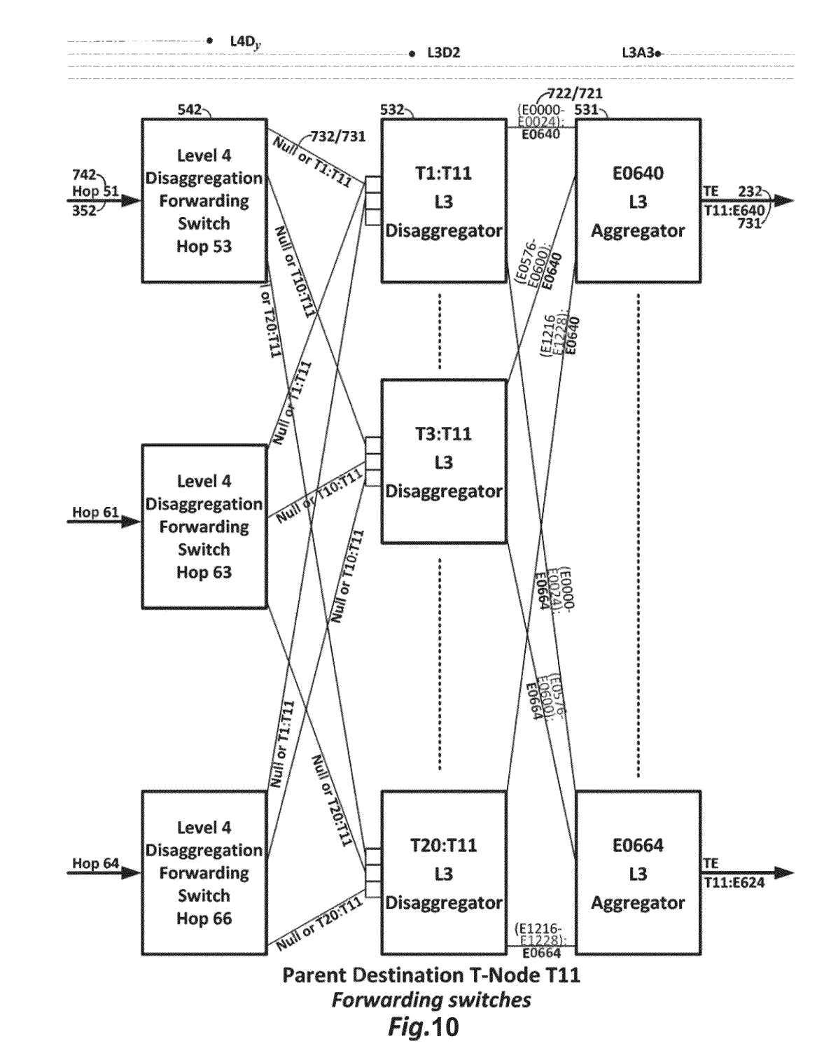

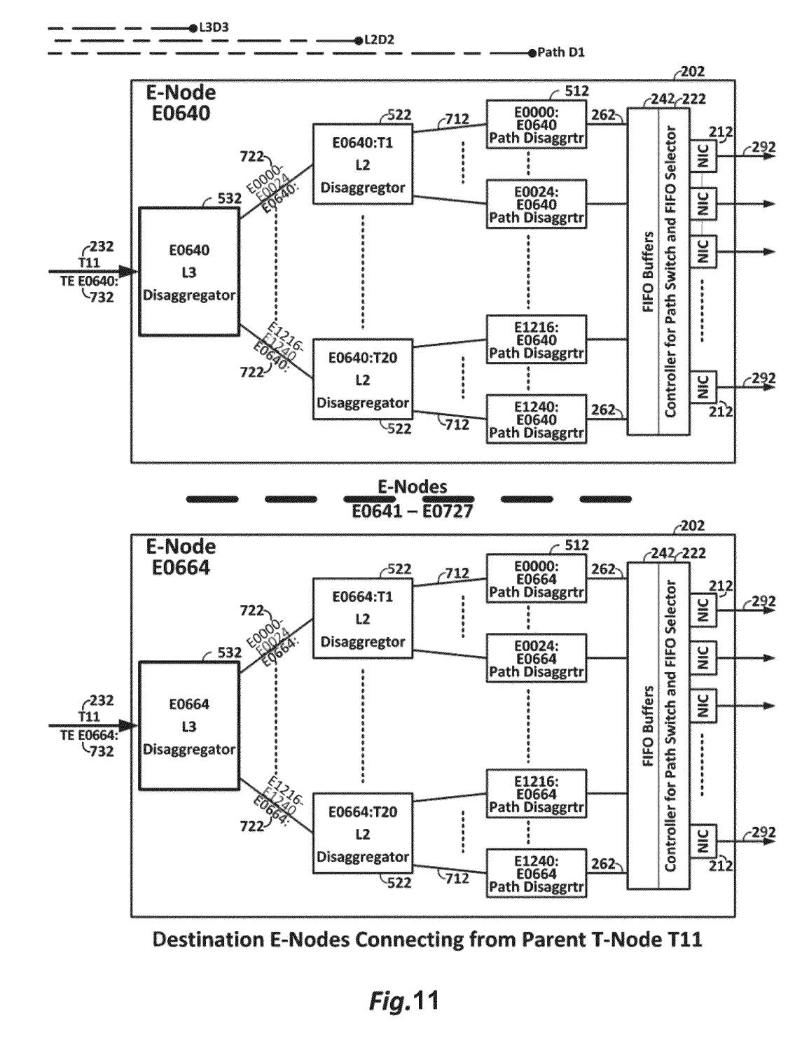

In an exemplary embodiment, A SAIN network, as shown in FIGS. 7 to 10, illustratively depicts how routes can be set up. Each of the Level 2 aggregations goes from each sE-Node with parent sT-Node 3 connecting to dE-Nodes with parent dT-Node 12. FIG. 1 shows the scene of all 20 T-Nodes and all 80 simplex trunks in a model network. Many possible routes exist between sT-Node 3 and dT-Node 12.

FIG. 7 shows there are five possible connections to each of the five outbound trunks (4, 14, 21, 23, 25) at parent sT-Node 3. A route can start over any one of the five. A table of routes between the source and destination can show the combination of latency and available bandwidth of each of the routes. The source route sT-Node 3 can provide guidance at every other T-Node of its role in a route if any. The messages are contained in (part of) a Control Vector (CV) message sent to those nodes that are going to forward a specific Level 2 route. The route can be set up once, but also monitored to assure continuously that it is working. In some embodiments, if it is not, another possible disjoint route exists in a virtual state so that only a very small amount of data need be lost.

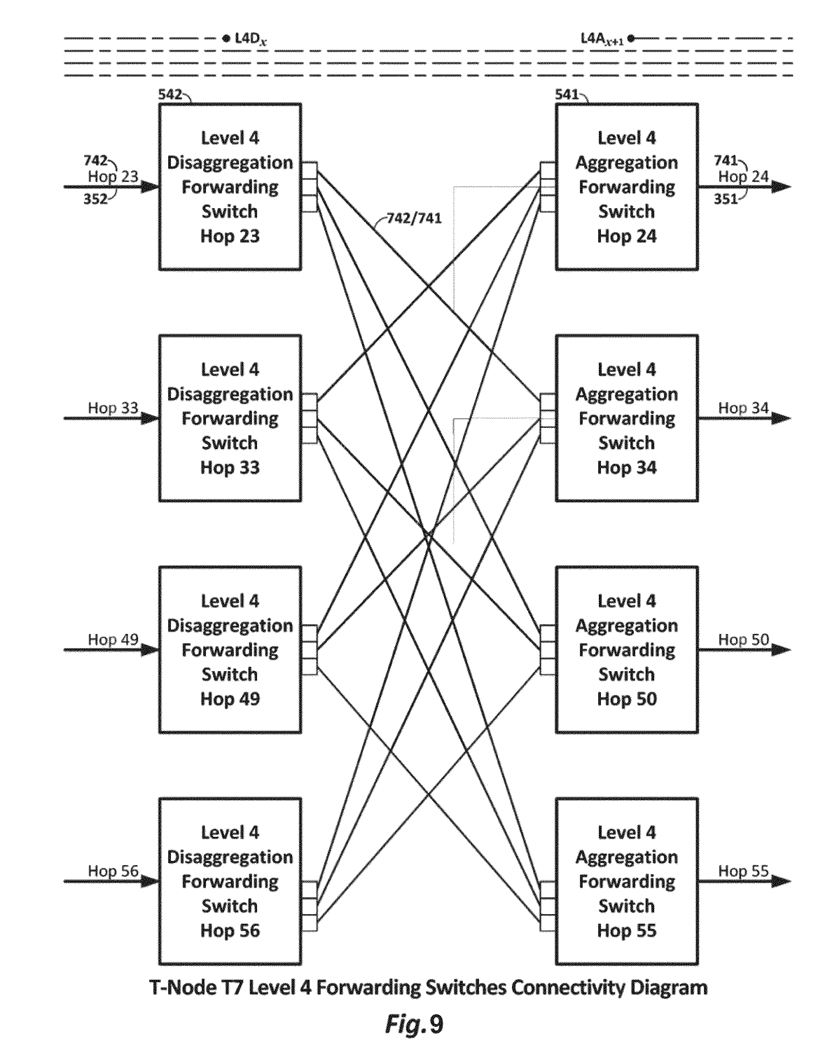

Each source sT-Node of what are Type II aggregator/disaggregator has at least one switch pair at every forwarding node for the number of possible connections to each possible next aggregation hop. Each switch can have a reserved position in a Circuit Domain for the route. For example, the Level 3 source aggregation node as chosen in FIG. 9 is trunk 23. The bandwidth for the connection can change periodically as it does for any point-to-point connection. There are always two states of activity about the amount of bandwidth allocated to a connection. In this case, there can be two state locations ‘A’ and ‘B’. If state location ‘A’ is active, state location ‘B’ is preparing for the next frame.

### Method of Removing Non-Message Part of a Packet with Extension of Past Connection Memories

User connections between a data source and a data sink can take advantage of a SAIN network type of system that can reduce using system bandwidth, increase network security, and reduce processor demand. The method can apply to many applications. An example used herein connects source NICs (sNICs) to destination NICs (dNICs) through a SAIN network with its transparent forwarding.

As a few exemplary examples, objects that can implement the methods include:
1. A sNIC connected to a dNIC through a SAIN transparent network
2. A data hash processor of a defined non-message portion of a data packet
3. Table of current virtual and real connections with hash table numbers
4. Hash table of past connected packets
5. Last sNIC-dNIC connection tables showing data sizes and time stamps.

The connection between a sNIC and a dNIC can be included in the sE-Node to dE-Node Level 2 aggregation that carries the appropriate Path Level 2 aggregation. The Path Level 1 aggregation 1) connects to an sSwitch in either a Path Level 1 connected to the Path Level 1 that connects to dSswitch in either a Path Level 1 connected to a dE-Node, or 2) to a plurality of connections that are included as sub-connections of Level 2 sSwitch to dSswitch connections.

In some embodiments, steps can be taken to before operation of the exemplary method:
1. Aspects of packets forwarded through network to include 1) source and destination addresses and 2) other defined non-message parts.
2. Determine number of hash entries in two columns, one relatively short and a longer one. For example, the short column can be taken to hold 256 sNIC-dNIC positions. As another example, a longer column can hold 4096 sNIC-dNIC positions. This can become an empty long after the 256 position short column has been deleted, with the oldest entry put into place as the newest entry.

Exemplary steps can further include the system sending packets through a SAIN network:
1. Use headers to divide the packets into 1) source and destination addresses and 2) protocols less CRC, message, and other defined variable parts into separate memory locations.
2. Process the resulting second part into a hash number.
3. The first hash appears in a three-column table, 1) one for the hash number (such as 64 or 128 bits), 2) a second for the location position number in the Circuit Domain of the sSswitch-dSswitch pair, 3) and the third is the time order of the row in which the packet last appeared. The first column (the hash number) sorts the table in hash-number-order from small to large number.
4. Initially, there are no entries in any column of the table. A first entry will be on the first row where the hash number occurs in the first column, the location position number in the second, and a zero in the third. [Instead of a fourth column in the table, there is a separate large column of hash numbers and their source values.]
5. The next packet will provide either a hash number (or less likely, a ‘yes’ or ‘no’ comparison on all of the values) for the packet source values. If the second packet is not the same as the first, all existing rows including the existing packet raise the third column value by ‘1’.
6. In one exemplary scenario, for each succeeding packet, if it is different from any prior packet, that will cause all other packets to increase their time order value by one.
7. If an entering packet is the same as a previous packet, the situation is different. The old packet's time order number is stored where the value can be used to determine whether or not each prior packet's time order value should be incremented by one or not. For each row in the three-column table, if the row in the third column table is less than the stored value, increase the value in the third row by ‘1’. If the value equals the stored value, replace the old value by ‘0’.
8. The number of rows in the three-column table is generally set up before use of the system. If a new packet appears and the number rᵢ rows equals the setup value, the last row memorialized the packet disappears with removal of the last row. A new first row becomes added as a new first row with a third column time order value of ‘0’.

A second table can be set up that is much larger than the one that is desirable for Circuit Domains in sSswitches and their paired dSswitches. Such a table can include the three columns described above. A fourth column can store matching data that led to a hash number.

If we limit the number of possible connection numbers to 256 (i.e., the first table), the Control Vector needs to identify one byte per connection. The connections can be virtual or real and if they are virtual, they can be set to using zero bandwidth for their bandwidth.

Suppose that the second number of past packets is 4,096. This method can enable matching current hash numbers with the past packets.

The systems and methods herein describe a new way of routing and forwarding connections with new architecture systems that can provide certain useful services, for example, providing access for large private networks, providing access to special services to many organizations such as large companies and government agencies. In some embodiments, this can occur in connection with wireless networks or optical networks.

The need for this approach comes from a fact that real-time flow-based traffic can dominate demands on today's Internet. There is an increasing need for large amounts of streaming data to arrive reliably, on-time and in-order.

In various embodiments, a Synchronized Adaptive INfrastructure (SAIN) is connectivity technology for a new conceptual Internet. The technology can include a very secure underlayer network that provides one-hop end-to-end service at very low latency. It can also use bandwidth efficiently, can be low cost, can be highly scalable, can be survivable, and can have low energy use.

In one embodiment, an application of SAIN network can be for emerging markets such as large private networks and large wireless networks, both of which can be at a global level, and will significantly lower CAPEX and OPEX cost. A connection can be disjoint from every other connection, resulting in superb security without depending on encryption.

As described herein, a SAIN network can support a global environment with a new routing strategy. This starts with a short summary on how a SAIN network works. Then, 1) defines what can cause a real routing problem, 2) show what has been difficult in the past, and 3) how the SAIN approach is much simpler with very low latency, high security and other improved performance.

### How a SAIN Network Works

Packet-based networks send packets one-at-a-time from a source ingress port to a destination egress port. Each packet passes hop-by-hop serially through tunnels or semi-randomly through multiple network links.

In various embodiments, a SAIN network does not send packets one-at-a-time—the network can forward a plurality of packets at the same time in orderly fashion as framed aggregations of packet fragments. A fragment, called a cellet, can be any fixed size (number of bits) for periodic frames. A cellet can represent a quantum of bandwidth that equals the size of a cellet divided by a frame period. Nominally, frame rates (the inverse of frame periods) can be constant over well-defined periods of use. However, the number of cellets in a frame can be variable. In other words, a frame's bandwidth can vary frame-by-frame as each packet can use bandwidth quanta only as long as portions of a packet exists. In between packet flows, the position of a circuit can remain in place consuming zero bandwidth.

The bandwidth of each circuit and frame can change quickly. How quickly depends on traffic needs. Often, ‘quickly’ can mean 1,000 times per second, i.e., sequentially in one millisecond periods. Changing parameters can, in some cases, require about two milliseconds.

A first millisecond can prepare bandwidth and other parameters of a Connection Domain in SAIN's transform algorithm that has two Domains—a Connection Domain and Space/Time Domain. The Connection Domain can exist in two states: a preparation state and an active state. The preparation state can use incoming data from users and network measurement inputs. Illustratively, once completed, a source node sends a Control Vector out-of-band signaling to a destination to synchronize the source and destination Circuit Domain preparation states prior to activation. Continuing in the same example, both source and destination nodes change to the newly prepared Circuit Domain as soon as the preparation period is finished. The Space/Time Domain can then change, upon changes to the Circuit Domain.

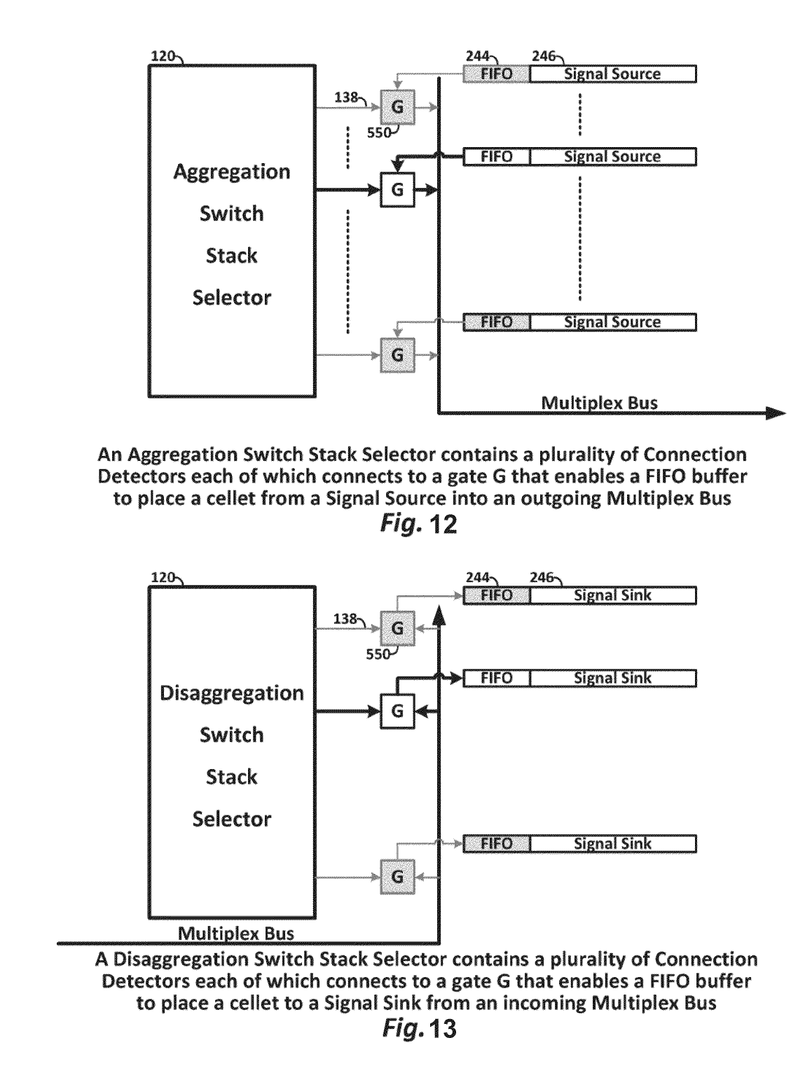

Each circuit in a SAIN network can carry individual packets or sequential packet flows. Each aggregation is a plurality of circuits that can exist in several hierarchical levels. There can be hop-by-hop forwarding of aggregations. A SAIN network can avoid the disadvantages of packet buffer complexity. In some embodiments, buffers exist only at ingress and egress ports. For example, FIGS. 12 and 13 show examples of buffers at aggregation and disaggregation switches that can exist an ingress and egress port respectively. As depicted in FIG. 12, an aggregation switch stack selector can include a plurality of connection detectors, each of which connects a gate that allows a FIFO buffer to place cellet from a source address (e.g., signal source) to an outgoing multiplex bus for the ingress port. As depicted in FIG. 13, an disaggregation switch stack selector can include a plurality of connection detectors, each of which connects a gate that allows a FIFO buffer to place cellet to a signal sink to an incoming multiplex bus for the egress port.

### A Fundamental Cause of Any Large Network's Routing Complexity

Illustratively, as any network grows in size, its connectivity can grow in a square-law fashion. For example, suppose that a small network has 20 ports. Each port connects to 19 ports—all ports except itself. Each port has the same number of connections resulting in 20×19=380 connections. Continuing in the same example, if the number of ports increases to 40, a factor of two, the number of connections per port increases to 39 and the network's number of connections become 1,560—nearly a factor of 4. In a fully connected network with n ports, every port can connect to n−1 other ports for a total number of connections equal to n×(n−1). Accordingly, in some embodiments, it may not be possible to connect all source ports with all destination ports for a long period of time (e.g., a fixed or virtual connection). Thus, in some embodiments, it may be advantageous to set up port pairs sporadically, as disclosed below.

The solution for the current Internet uses the idea of an Autonomous System (AS) separation of a network into seemingly arbitrarily small parts. In an exemplary SAIN network (e.g., with a particular structure), each part of a SAIN network may be an Autonomous Partition (AP). A global SAIN network can divide into a number of disjoint partitions each of which may contain disjoint connections between ports. Each partition can connect to another partition in a novel way described below using dual level approaches.

In one embodiment, each forwarding object in a SAIN network can divide into two parts—a source Part (sPart) and a destination Part (dPart). This s/d notation endures herein.

### The Basic Structure of a SAIN Network Connectivity Object Pairs Work

In an illustrative global SAIN network, there can be four tiers of nodes. At each level, there can exist one-hop aggregation/disaggregation switch pairs (aS/dS pairs). An aS/dS switch structure can be the same at any level of aggregation that has a higher aggregation level. An aS can connect to an aS at a next higher tier level or to a dS forwarding switch. A dS can connect to an aS forwarding switch or to a dS at a next lower tier level. A forwarding switch can maintain a tier level of aggregation.

The lowest tier (Path Level 1) can occur in nodes called Virtual Entry/Exit Nodes (VE-Nodes). A source VE-Node (i.e., sVE-Node) can aggregate all circuit connections from data-source ingress ports and connect one-hop to common locations of data-destination egress ports. A destination VE-Node (dVE-Node) can disaggregate circuit connections to data-destination egress ports.

The next higher-level nodes are Entry/Exit Nodes (E-Nodes). These nodes are the core of a SAIN network. Each E-Node can have a virtual connection to every other E-Node in a network or to a connected plurality of networks. Such connections are in an anticipated virtual state that can become a real physical state. In other words, a virtual state connection can have known routes prior to need. Below is a description of the SAIN simple method of this property.

Like all connection objects, a VE-Node and E-Node can each divide into two parts, a sVE-Node/dVE-Node pair and a sE-Node/dE-Node pair. Illustratively, each sE-Node can aggregate Path Level 1 sVE-Node aggregations that enter a sE-Node and terminates in physically connected dE-Nodes that, in turn, can connect to dVE-Nodes that disaggregates into egress port connections.

In various embodiments, a given partition of a global SAIN network can be a cluster of E-Nodes that connect to a parent Transit Node (T-Node). (Other possibilities can interconnect nodes, for instance for redundancy.) Like other tier nodes, each T-Node can divide into a sT-Node and a dT-Nodes. A sT-Node can aggregate separate sE-Node aggregations from its cluster to terminate in each dT-Node cluster in a global network partition. For example, this can include backhaul to a dT-Node in the same T-Node as a sT-Node.

In various embodiments, the bulk of connections in a SAIN network can be these first three tier of nodes. However, in some embodiments, a fourth level tier can be called an eXchange Node (X-Node) with sX-Node and dX-Node parts. An X-Node can sit atop a collection of T-Nodes (e.g., a cluster of T-Nodes) and/or a collection of APs each of which has one or more T-Nodes. An X-node can be located at a data center where data is processed in large quantities. For example, in one embodiment, an X-node can process data at 100 Gbps. Illustratively, in various embodiments, an X-node can be coupled to a fiber optic network or be a part of the fiber optic network, for example, as a switch.

### How a SAIN Network Finds Routes Prior to Use

Prior to use, a simple SAIN algorithm can calculate all possible loop-free routes among T-Nodes prior to use. As a result, a SAIN network can route large enough data aggregations between T-Node pairs so that the Law of Large Numbers can smooth out bursty packets without congestion by changing just enough bandwidth quickly

A controller at each source can choose desirable routes between source and destination nodes from among a large plurality of possibilities. For example, the system measures the available bandwidth of each possible route periodically (e.g., 1,000 times per second). In addition, at installation, the system can have measured the latency of each trunk in the network so that calculating the latency of a route is exists before use. Choosing the lowest latency route with just enough bandwidth for an aggregation (taking into account one-way propagation delay) can minimize the replacement cost, i.e., long-term cost of a network.

The controller can also use multiple routes for source to destination T-Node connectivity. This can provide various ways of overcoming faults and improving management of route bandwidth.

### When to Use VE Nodes

As an illustrative example, each E-Node can have data source ports, each of which can send data to destination ports that are in selected network partitions or to the public Internet. Each E-Node can further have data destination ports that may be restricted to selected partitions. In order to maintain public Internet security, a destination NIC or other similar object can restrict data from a selected protocol, such as PDF and perhaps OCR.

A VE-Node can connect to each of its parent E-Nodes with every other node efficiently in a selected partition that will send a large amount of traffic. In one embodiment, a VE-Node can be implemented when data traffic is most homogeneous. For example, this can occur in a SAIN network made up of a plurality of partitions that are set up to encapsulate ports most likely to be sources and destinations of traffic. Such partitions can include areas where people and machines are most likely to communicate with one another.

Large data centers can be such places. Illustratively, they can likely benefit from partitioning into clusters of use. A major benefit of partitioning source ports by class of use for data centers is that that can make best use of server types and storage. Dividing networks into partitions can have another benefit: The number of source E-Nodes can be small so that routing therein is simple.

### Dual VE-E-Node can be within a Single X-Node

In one embodiment, E-Nodes in a network partition can connect to a relatively small number of other E-Nodes both inside and outside selected partitions. In this instance, a sE-Node may need to connect to a limited number of dE-Nodes with a limited number of Path Level 1 connections. Anywhere in a network, there may be times of day with only a small amount of traffic.

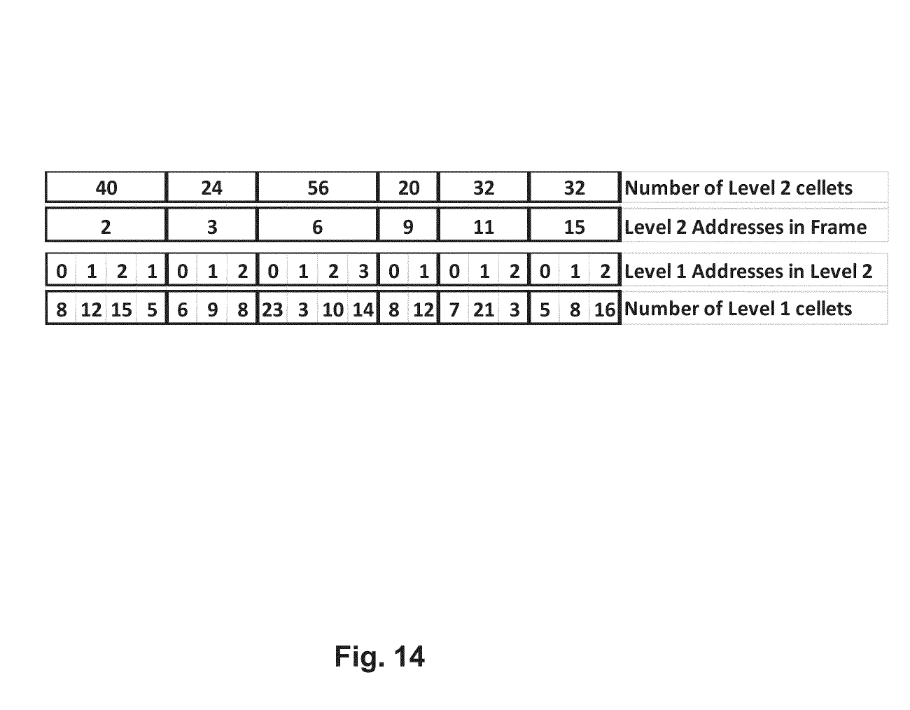

One method of supporting these low traffic conditions can be to use existing Level 2 forwarding and add a Path Level 1 layer to the Level 2 in a frame. FIG. 14 shows, in one embodiment, how this can be implemented.

As described above, VE-Nodes can benefit users clustered together and on the source side of data centers. In this embodiment, the distribution side of a data center can be another application. Dual VE-E-Nodes can come into play. FIG. 14 shows an example of Level 2 addresses that turned on with a number of cellets needed for the Path Level 1 traffic.

These values can use Control Vectors such as employed with larger traffic where Level 2 bandwidth uses 8-bit bytes to in one-bit cellets.

Using modular source and destination switches can extend this method to much more traffic.

### Extending Dual VE-E-Nodes beyond a Single X-Node

Networks can have distributions (e.g., non-Gaussian probability distributions) that show that clusters of traffic generate more traffic than do widely distributed traffic generators. In many empirical observations, heavy traffic compared to light traffic has something close to 80% of traffic distributing among clusters. In other embodiments, the smaller number outside a cluster can result in widely dispersed traffic.

For a SAIN network, routing and forwarding aggregations can be, in some embodiments, methods to reduce latency, for example, forwarding traffic can be deterministic. In one embodiment, this may result in an optimal condition that reduces latency while forwarding traffic simultaneously. Using SAIN routing techniques may require a higher tier to result in a simple approach. In addition, changing bandwidths of connections over very long distant connections may require using two-way management control of available bandwidth. Reserving bandwidth prior to use can overcome rapidly changing propagation delay.

In various embodiments, other portions of global network can be accessed through T-Nodes. In this example, a T-Node inside a partition can set up connections through its X-Node top tier to another X-Node using SAIN routing techniques. In another example, Partitions selected for interconnectivity can include matching NICs and authorization methods.

### Virtual Connections in Circuit-Based Networks

Systems and methods for providing circuit-centric, frame-based communications, with connections at ingress and egress nodes of a network are described herein. The connections can be configured based on network load, with some connections appearing as virtual connections in a “sleep state” if network load decreases. For example, in a fiber optic network, the connections can be configured for communication on particular wavelengths in combination with “virtual circuits,” alternating between active and sleep states as network load requires.

Virtual connections can exist between E-Nodes and their respective ports and/or their respective NICs. In some embodiments, the bulk of the virtual connections can be sleep mode that can become real (e.g., active). For example, in one embodiment, a couple of milliseconds plus (probably one-way) propagation delay can transition a virtual connection from sleep mode to active mode.

In one embodiment, a Control Vector (CV) can be replenished in a periodic one millisecond epoch plus an automatic setup period whose period should be less than a second millisecond. Although, in some embodiments, an epoch can be shortened by using more bandwidth applied to CVs. One millisecond may sound short compared to the time to store data in a packet from a serial data source such as real-time conferencing, VOIP and LTE epochs. In one embodiment, a limiting element of latency can be a propagation delay. In some embodiments, a SAIN network does not need packet buffers, which may result in less congested, or no congestion, within a network as long there is enough bandwidth for sending an aggregation of packets simultaneously during an epoch. Continuing in these embodiments, the result is one-hop connectivity with very low latency.

In one embodiment, two-way verification of a CV to set up a connection not used previously or a connection that was used a long period time ago (e.g., 3 days or one year) may occur only infrequently. Some embodiments of connection setup can use error correction of a CV. Illustratively, the expected BER of a 500 Gbps optical trunk can be between 10̂-15 and 10̂-30. In some embodiments, a higher error rate of greater than 10̂-10 may lead to decommissioning of a particular optical trunk. In some embodiments, short CVs are likely to exist in Layer 1 aggregations in many cases. In these embodiments, the length of such a CV could reduce the likelihood of a critical error by one or two orders of magnitude, as compared to current packet-based methods.

In some embodiments, CVs can be based on local one-hop addressing where the ordinal location of a connection in a Connection Domain supports a physical connection. Parameters of a CV can include data rate for a packet, data rate for a packet flow, and packet lengths after having removed packet headers. Illustratively, removing packet lengths can enhance security or avoid the disadvantages of insecure methods found in TCP/IP networks.

From a logical perspective, there can be virtual Level 2 aggregations of Path Level 1 aggregations between any two E-Nodes in a global SAIN network. In one embodiment, these can become active only when there is one or more Level 1 data flows between an E-Node pair. For example, the amount of effort to make an aggregation real (e.g., active) may take milliseconds in a well-defined network. Continuing in this example, this can includes pairing E-Nodes that exist in different X-Nodes.

In various embodiments, once a connection is set up, a connection can be memorialized into being a virtual connection that can be placed in an ‘on’ state from an ‘off’ state. Once in an ‘on’ state, a connection can be in either an active or a sleep state. User data connections can be forwarded in a Level 1 aggregation over a one-hop circuit. In one embodiment, the number of connections can be limited by the trunk bandwidth (e.g., an optical trunk) and/or an arbitrary maximum number of cellets in a frame. SAIN source and destination Sswitches can be built as addressable switch modules. Whatever the range of input data rates is in a single epoch, the total amount of bandwidth is known as a CV is setup so that the number of modules required can be known and can be known in that period.

In some embodiments, the Sswitchs can use a 4:1 ratio or a 3:1 ratio. For example, three virtual circuits can be in a sleep state for every active state circuit. The three virtual circuits in the sleep state may consume no data channel bandwidth. In one embodiment, the three virtual circuits may consume a one bit per periodic epoch in a CV. Comparatively to an active connection, this can be a small bandwidth.

In some embodiments of a SAIN network, the bandwidth for a large number of active connections (e.g., 1000) can be contained in a single Layer 2 aggregation. The aggregation's plurality of circuits can be in a single route or divided into multiple routes between a single source and a destination. In one embodiment, the Law of Large Numbers may apply before reaching such a large number of active connections (e.g., 1001). As one example, setting up and tearing down (including either into a sleep state or an ‘off’ state) connections can occur in one or two milliseconds.

The number of Layer 2 aggregations can depend on the number of destination E-Nodes that have disjoint connections to a source E-Node. For example, if there are 40 destination E-Nodes, there are also 40 source E-Nodes, each of which connects to the 40 destination E-Nodes. In other words, for a cluster of 40 EC-Nodes to a T-Node, there are 40×40=1600 source E-Node to destination E-Node connections. In another example, if there is an average of 100 connections (i.e., 100,000 connections per second) for each E-Node pair. and if each connection sends a 5,000-bit frame, the total bandwidth for each source E-Node to destination E-Node connection would be 500 Mbps, which would result in each E-Node in a cluster sending 40×500=2 Gbps. Accordingly, in this example, the total bandwidth for a cluster is 40×2=80 Gbps. Continuing further in this example, if there are 20 T-Nodes in a network, the total bandwidth can be 1.6 Tbps. In various embodiments, this may result in no packet congestion. The total bandwidth of a network can depend on the number of E-Nodes. The number of T-Nodes can be to diversify physically network forwarding objects for reliability and survivability.

In many data centers, connectivity bandwidth is oversubscribed by a factor of 4 times the data rate that may be required for a single connection. In various embodiments of a SAIN network, the total connectivity is not based on oversubscription. Instead, connectivity can be maintained with virtual connections in a sleep mode—in order to place them from virtual mode to an active mode, on demand in a short time period (e.g., a couple of milliseconds). In another example, a factor of nine sleep mode connections for each active connection would bring the total available connections to 1,000 instead of 100. In this example, total trunk bandwidth capacity between T-Nodes may limit the real-world upper limit of activity/bandwidth.

In various embodiments, E-Node Ports, E-Nodes (with or without VE-Nodes), and T-Node in each X-Node can use IPv6 addressing. For example, a possible numbering plan can provide 16 bits to define the maximum number of ports with NICs connected to an E-Node and 16 bits for each T-Node|E-Node pair, divided as necessary on a case-by-case basis between the two. Another 16 bits can be for the number of data sources and data sinks for each E-Node. Continuing in this example, this would leave an additional 16 bits for other purposes.

Each of the processes, methods, and algorithms described herein and/or depicted in the attached figures may be embodied in, and fully or partially automated by, code modules executed by one or more physical computing systems, hardware computer processors, application-specific circuitry, and/or electronic hardware configured to execute specific and particular computer instructions. For example, computing systems can include general purpose computers (e.g., servers) programmed with specific computer instructions or special purpose computers, special purpose circuitry, and so forth. A code module may be compiled and linked into an executable program, installed in a dynamic link library, or may be written in an interpreted programming language. In some implementations, particular operations and methods may be performed by circuitry that is specific to a given function.

Further, certain implementations of the functionality of the present disclosure are sufficiently mathematically, computationally, or technically complex that application-specific hardware or one or more physical computing devices (utilizing appropriate specialized executable instructions) may be necessary to perform the functionality, for example, due to the volume or complexity of the calculations involved or to provide results substantially in real-time. For example, a video may include many frames, with each frame having millions of pixels, and specifically programmed computer hardware is necessary to process the video data to provide a desired image processing task or application in a commercially reasonable amount of time.

Code modules or any type of data may be stored on any type of non-transitory computer-readable medium, such as physical computer storage including hard drives, solid state memory, random access memory (RAM), read only memory (ROM), optical disc, volatile or non-volatile storage, combinations of the same and/or the like. The methods and modules (or data) may also be transmitted as generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). The results of the disclosed processes or process steps may be stored, persistently or otherwise, in any type of non-transitory, tangible computer storage or may be communicated via a computer-readable transmission medium.

Any processes, blocks, states, steps, or functionalities in flow diagrams described herein and/or depicted in the attached figures should be understood as potentially representing code modules, segments, or portions of code which include one or more executable instructions for implementing specific functions (e.g., logical or arithmetical) or steps in the process. The various processes, blocks, states, steps, or functionalities can be combined, rearranged, added to, deleted from, modified, or otherwise changed from the illustrative examples provided herein. In some embodiments, additional or different computing systems or code modules may perform some or all of the functionalities described herein. The methods and processes described herein are also not limited to any particular sequence, and the blocks, steps, or states relating thereto can be performed in other sequences that are appropriate, for example, in serial, in parallel, or in some other manner. Tasks or events may be added to or removed from the disclosed example embodiments. Moreover, the separation of various system components in the implementations described herein is for illustrative purposes and should not be understood as requiring such separation in all implementations. It should be understood that the described program components, methods, and systems can generally be integrated together in a single computer product or packaged into multiple computer products. Many implementation variations are possible.

The processes, methods, and systems may be implemented in a network (or distributed) computing environment. Network environments include enterprise-wide computer networks, intranets, local area networks (LAN), wide area networks (WAN), personal area networks (PAN), cloud computing networks, crowd-sourced computing networks, the Internet, and the World Wide Web. The network may be a wired or a wireless network or any other type of communication network.

The systems and methods of the disclosure each have several innovative aspects, no single one of which is solely responsible or required for the desirable attributes disclosed herein. The various features and processes described above may be used independently of one another, or may be combined in various ways. All possible combinations and subcombinations are intended to fall within the scope of this disclosure. Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. No single feature or group of features is necessary or indispensable to each and every embodiment.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y and at least one of Z to each be present.

Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one more example processes in the form of a flowchart. However, other operations that are not depicted can be incorporated in the example methods and processes that are schematically illustrated. For example, one or more additional operations can be performed before, after, simultaneously, or between any of the illustrated operations. Additionally, the operations may be rearranged or reordered in other implementations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

1. A method of forming a connection domain, the method comprising:
identifying a plurality of network nodes in a network system;
partitioning the plurality of network nodes into a disjoint network element;
identifying, based on the disjoint network element, a first virtual connection between an entry node and an exit node;
assigning a first bandwidth to the first virtual connection; and
forming a connection domain among the partitioned plurality of network nodes, the connection domain including the first virtual connection.

2. The method of claim 1 further comprising:
receiving, from an external device of the network system at a path level, path level data;
activating the identified first virtual connection for transmission of the path level data; and
transmitting the path level data as cellets via the activated first virtual connection to a destination address, wherein a size of each cellet corresponds proportionally to the first bandwidth.

3. The method of claim 2, wherein activating the identified first virtual connection for transmission of the path level data comprises generating a control vector that implicitly addresses a first cellet for transmission of the path level data to the destination address.

4. The method of claim 2, wherein transmitting the path level data as the cellets via the activated first virtual connection comprises transmitting the cellets at an exit data rate at the exit node that is faster than an entry data rate at the entry node.

5. The method of claim 2, wherein receiving path level data comprises receiving data from a network interface controller.

6. The method of claim 2, wherein receiving path level data comprises receiving data from a first Ethernet network interface card.

7. (canceled)

8. The method of claim 1, wherein the identified first virtual connection includes at least one network switch configured to convert the path level data into implicitly addressed data.

9. (canceled)

10. The method of claim 1 further comprising:
identifying, with implicit addressing, a portion of path level data communicated via the first virtual connection based at least in part on a position of said portion of the path level data in a path frame;
aggregating, at an egress-node (“E-node”) network level, the path level data into a plurality of superpath frames; and
further aggregating, at the transit-node (T-node) network level, said plurality of superpath frames into a plurality of T-node level frames.

11. (canceled)

12. The method of claim 2, wherein said activated virtual connection is at least one of a 3 Gbps data connection over an optical fiber or a wireline.

13. (canceled)

14. The method of claim 1, wherein the destination address corresponds to at least one of a source MAC address, a destination MAC address, a source IP address, a destination IP address, or an MD5 header.

15. The method of claim 1, wherein the method is performed by a circuit-switch (C-switch) of a telephone network.

16. A system for forming a connection domain, the system comprising:
a network switch;
one or more processors; and
tangible, non-transitory computer storage that stores a program that when executed by the one or more processors is configured to perform operations for forming a connection domain comprising:
identify a plurality of network nodes in a network system;
partition the plurality of network nodes into at least two disjoint network elements;
identify, based on the at least two disjoint network elements, a virtual connection between an entry node and an exit node;
assign a first bandwidth to the first virtual connection; and
forming a connection domain among the partitioned plurality of network nodes, the connection domain including the first virtual connection.

17. The system of claim 16, the one or more processors further configured to perform operations comprising:
assigning a virtual partition to the entry node and the exit node for facilitation of a continuous connection during transmission of network data communication.

18. The system of claim 16, wherein partitioning the plurality of network nodes into at least two disjoint network elements comprises identifying at least one network node configured to act as independent network switch.

19. The system of claim 16, the one or more processors further configured to perform operations comprising:
receive, from an external device, path level data;
activating the identified virtual connection for transmission of the path level data; and
transmitting the path level data as cellets via the activated virtual connection to a destination address, wherein a size of each cellet corresponds proportionally to the first bandwidth.

20. The system of claim 16, wherein the network switch corresponds to a circuit-switch (C-switch) of a telephone network.

21. The system of claim 19, the one or more processors further configured to perform operations comprising:
alternating the identified virtual connection between an active state and a sleep state based on network load.

22. The system of claim 21, wherein alternating the identified virtual connection between the active state and the sleep state comprises changing the identified virtual connection from the active state to the sleep state according to a demand for the network load.

23. The system of claim 16, wherein identifying the virtual connection between the entry node and the exit node comprises determining a plurality of routes for transmitting cellets among the plurality of nodes.

24. The system of claim 21, wherein the identified virtual connection is associated with the determined plurality of routes.
